(19) United States
(12) Patent Application Publication
(10) Pub. No.: US 2003/0177123 A1
(43) Pub. Date: Sep. 18, 2003

(54) Field replacement system and method

(75) Inventors: Donna L. Edwards, Brighton, MI (US); Steven W. Joyner, Milford, MI (US)

Correspondence Address: General Motors Corporation, Legal Staff, 300 Renaissance Center, P.O. Box 300, Mail Code 482-C23-B21, Detroit, MI, 48265-3000, US

(73) Assignee: General Motors Corporation

(21) Appl. No.: 10/097,880

(22) Filed: Mar. 14, 2002

(51) Int. Cl. G06F 17/30; G06F 7/00

(52) U.S. Cl. 707/10

(57) ABSTRACT

A system for implementing a method for monitoring one or more field replacements of a component. The system receives and stores field allotment data and field replacement data associated with the component in a relational database. The system retrieves at least the field replacement data to communicate a field replacement indicator to a monitor of the system. The communication provides relevant information concerning a number or a rate of field replacements of the component.

### BACKGROUND OF THE INVENTION

1. Field of the Invention

The present invention generally relates to field replacement systems and methods. The present invention particularly relates to a method of establishing and populating a database system employed to facilitate monitoring of field replacements of parts.

2. Description of the Relatedn Art

In one known method of monitoring parts, an inspector completes a paper form having data related to an inspection of a defective part returned from the field, and either faxes or e-mails the paper form to the manufacturer of a unit employing the defective part. The data is thereafter manually entered into a database to facilitate a future reporting and analysis of economic and logistic issues related to the warranties.

There are numerous drawbacks to the aforementioned prior art, such as the time consumption in manually entering the data into the database. The present invention addresses these drawbacks.

### SUMMARY OF THE INVENTION

The present invention relates to a field replacement database system and method that overcomes the aforementioned disadvantages of the prior art. Various aspects of the invention are novel, non-obvious, and provide various advantages. While the actual nature of the present invention covered herein can only be determined with reference to the claims appended hereto, certain features, which are characteristic of the embodiments disclosed herein, are described briefly as follows.

In one example of the present invention, field replacement data representative of one or more field replacements of a component is received and stored. Second, a field replacement indicator indicative of the number of field replacements of the component is communicated.

In a second example of the present invention, field replacement data representative of one or more field replacements of a component is received and stored. Second, a number of field replacements of the component within a time period is computed. Third, a field replacement indicator indicative of the number of field replacements of the component within the time period is communicated.

In a third example of the present invention, field allotment data representative of one or more allotments of a component in the field and field replacement data representative of one or more field replacements of the component are received and stored. Second, a rate of field replacements of the component per field allotments of the component is computed. Third, a field replacement indicator indicative of the rate of field replacements of the component per field allotments of the component is communicated.

In a fourth example of the present invention, field replacement data representative of a field replacement of a component is received and stored. Second, a further repair needed indicator is communicated when the field replacement data indicates a unit employing the component in the field is in a state needing repair due to a sub-optimal performance of the component.

The foregoing forms, and other forms, features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 illustrates an example of the present invention within a private intranet;

FIG. 2 illustrates an example data flow diagram involving software modules of the FIG. 1 system;

FIG. 3 illustrates another example data flow diagram involving software modules of the FIG. 1 system;

FIG. 4 illustrates an example flow chart representative of a method in accordance with the present invention;

FIG. 5 illustrates an example flow chart representative of field allotment data extraction steps for use with the present invention.

FIG. 6 illustrates an example flow chart representative of field replacement data presentation steps for use with the present invention; and

FIG. 7 illustrates an example flow chart representative of field replacement data acquisition steps for use with the present invention;

FIG. 8 illustrates an example flow chart representative of field replacement indicator generation steps for use with the present invention; and

FIG. 9 illustrates an example flow chart representative of field replacement indicator generation steps for use with the present invention.

### DETAILED DESCRIPTION OF THE PRESENTLY PREFERRED EMBODIMENTS

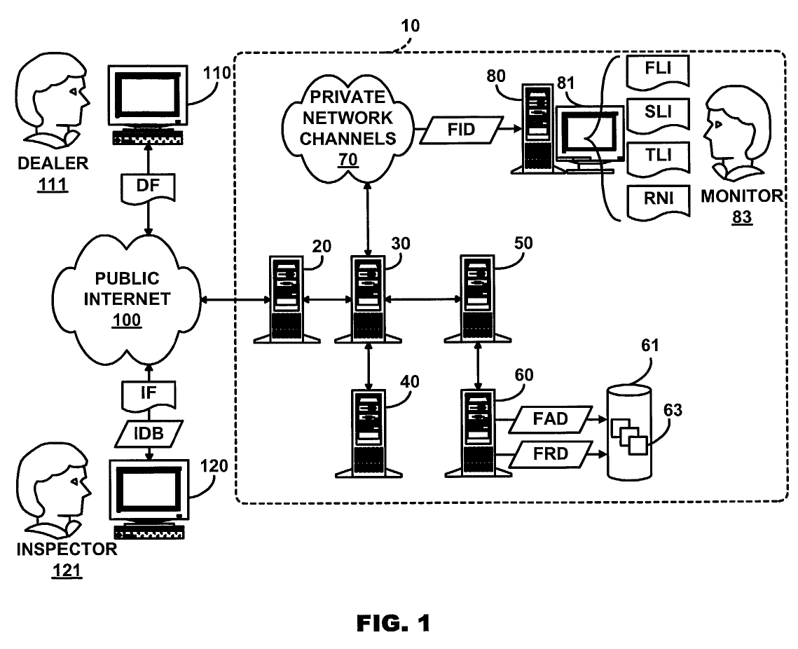

FIG. 1 illustrates hardware components of a system 10 of the present invention employed within a private intranet. The system 10 includes a firewall 20, a web server 30, a security server 40, an application server 50, a relational database server 60 having a relational database 61, an arrangement of private network channels 70, a monitor server 80 and a monitor workstation 81. The hardware components of the system 10 are commercially available products.

Also illustrated in FIG. 1 is a public Internet 100, a dealer personal computer (“PC”) or workstation 110, and an inspector PC or workstation 120. Any communication between the system 10 and the dealer PC and workstation 110 and any communication between the system 10 and the inspector PC and workstation 120 is accomplished via the firewall 20 and the public Internet 100.

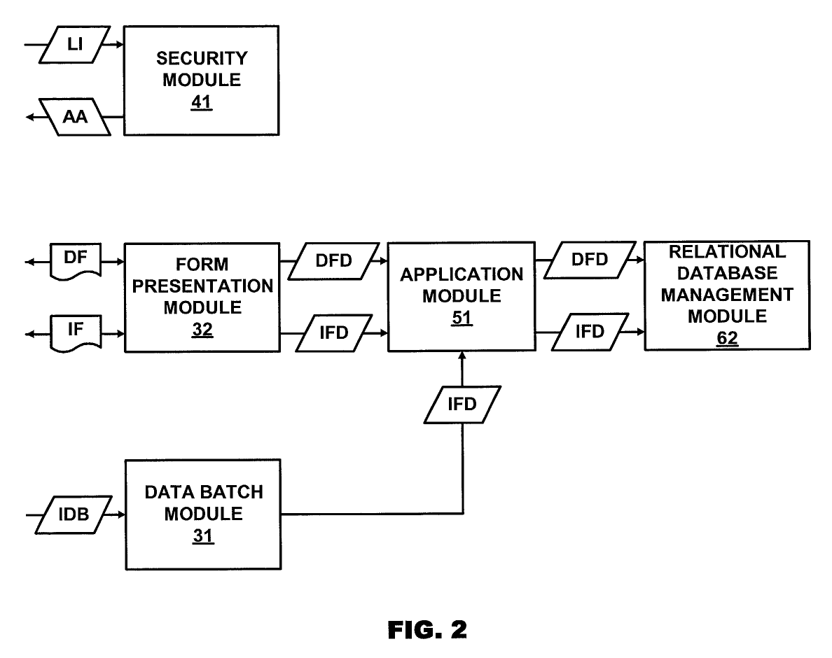

FIG. 2 illustrates software modules of the system 10 for controlling storage of field replacement data FRD within a set of relational tables 63 of the relational database 61 (FIG. 1) in accordance with the present invention. The field replacement data FRD is indicative of one or more field replacements of a component due to sub-optimal performance(s) of the component in the field. The level of detail of the field replacement data FRD can vary between a general identification of the component (e.g., the name of the component.) and a specific identification of the component (e.g., a specific brand, name, size and type and reason for sub-optimal performance).

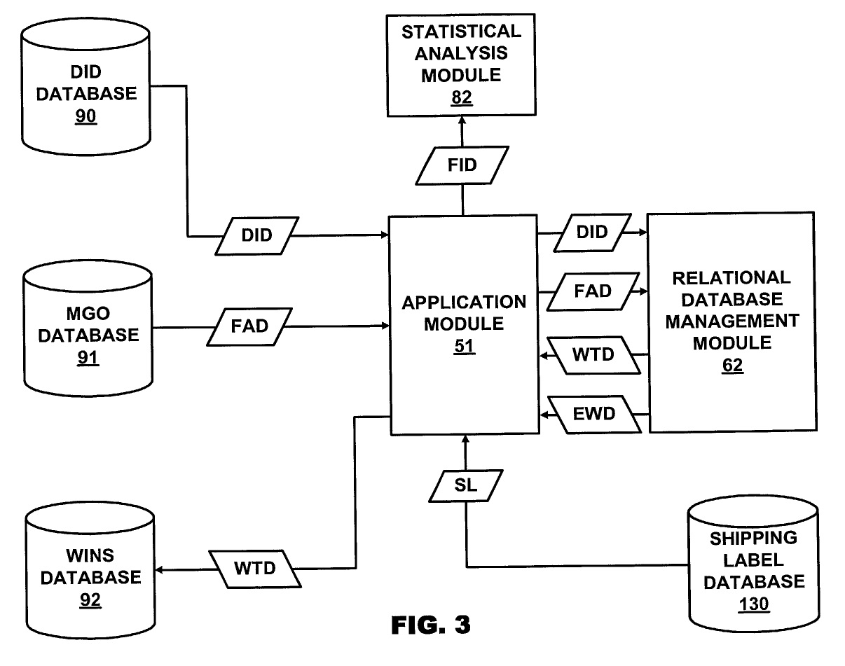

FIG. 3 illustrates software modules of the system 10 for controlling storage of field allotment data FAD within the relational tables 63 of relational database 61 in accordance with the present invention. The field allotment data FAD is indicative of one or more allotments of a component in the field with the allotments including a number of the component allotted to be assembled on units or goods to be sold and/or a number of the components assembled on goods that are ready for shipping to the field. The level of detail of the field allotment data FAD can also vary between a general identification of the component and a specific identification of the component.

The software modules illustrated in FIG. 3 also selectively generate field replacement indicators in the form of a first level indicator FLI (FIG. 1), a second level indicator SLI (FIG. 1), and/or a third level indicator TLI (FIG. 1) in accordance with the present invention. The first level indicator FLI is indicative of the number of field replacements of the component being greater than a predetermined threshold X. The third level indicator TLI is indicative of the number of field replacements of the component being less than a threshold Y. The second level indicator SLI is indicative of the number of field replacements of the component being between the threshold X and the threshold Y.

The software modules of the system 10 are a data batch module 31, a form presentation module 32 and a security module 41 illustrated in FIG. 2; an application module 51 and a relational database module 62 illustrated in FIGS. 2 and 3; and a statistical analysis module 82 illustrated in FIG. 3. The data batch module 31, the form presentation module 32 and the security module 41 are operatively installed within the web server 30 (FIG. 1). The security module 41 is operatively installed within the security server 40 (FIG. 1). The application module 51 is operatively installed within the application server 50 (FIG. 1). The relational database management module 62 is operatively installed within the database server 60 (FIG. 1). The statistical analysis module 82 is operatively installed within the monitor server 80 (FIG. 1). The security module 41, the relational database management module 62, and the statistical analysis module 82 are commercially available software programs. The data batch module 31, the form presentation module 32, and the application module 51 are software programs in JAVA language specifically designed and programmed for the system 10. Collectively, the software modules of the system 10 control an implementation of a method in accordance with the present invention.

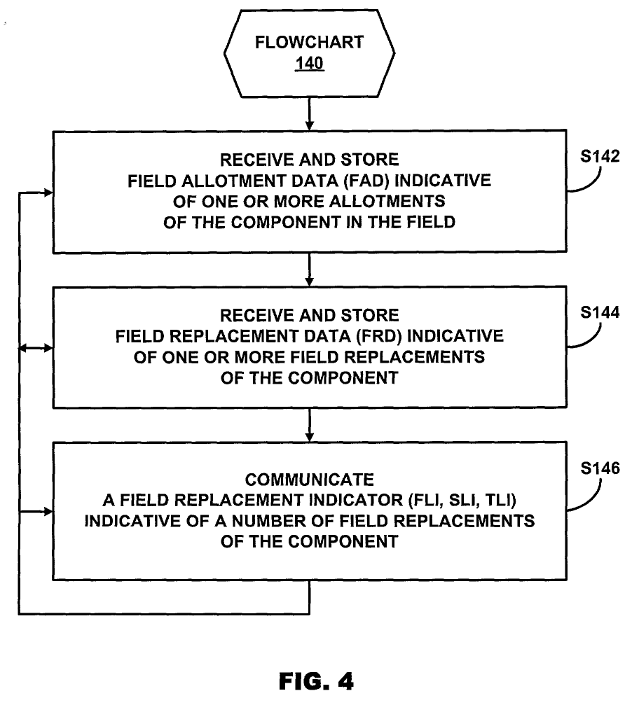

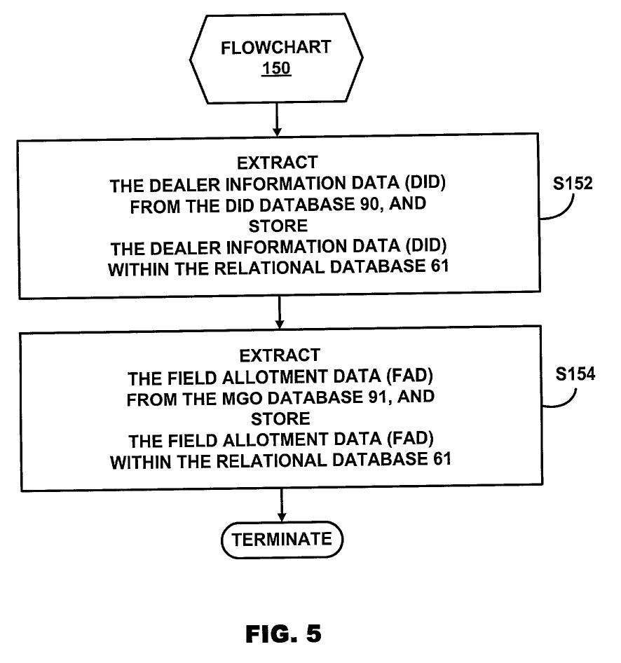

FIG. 4 illustrates a flowchart 140 as a representation of the method of the present invention. During a stage S142 of the flowchart 140, the application module 51 and the relational database management module 62 control a reception and storage, respectively, of the field allotment data FAD in the relational tables 63 of the relational database 61 as illustrated in FIG. 1. In one embodiment, during the stage S142, the application module 51 and the relational database management module 62 implement a field allotment data extraction method of the present invention that will be subsequently described herein in connection with FIG. 5.

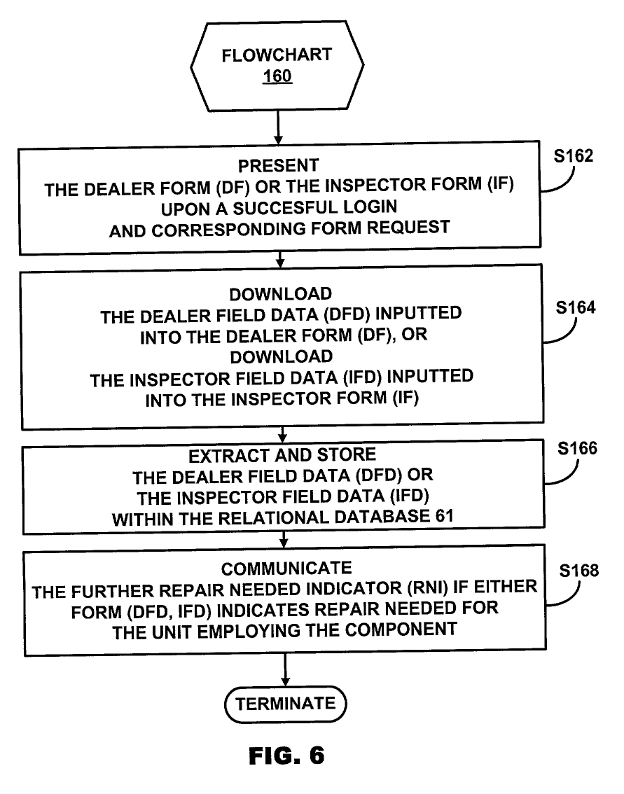

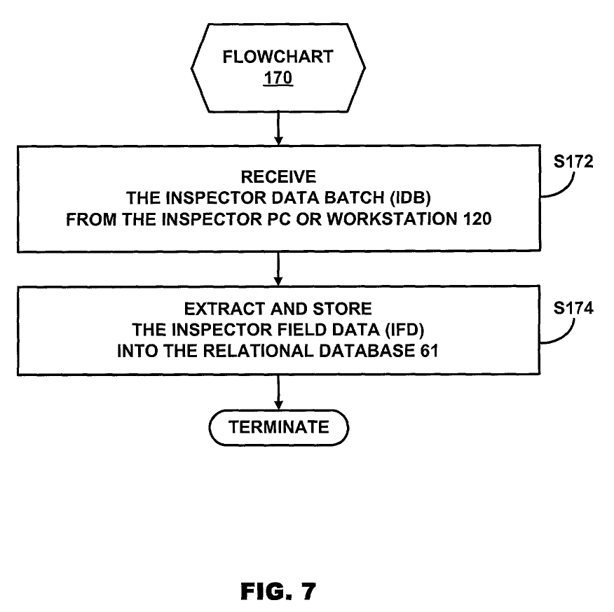

During a stage S144 of the flowchart 140, the application module 51 and the relational database management module 62 control a reception and a storage, respectively, of the field replacement data FRD in the relational tables 63 of the relational database 61. In one embodiment, during the stage S144, the application module 51 and the relational database management module 62 selectively implements a field replacement data presentation method of the present invention that will be subsequently described herein in connection with FIG. 6 and a field replacement data acquisition method of the present invention that will be subsequently described herein in connection with FIG. 7.

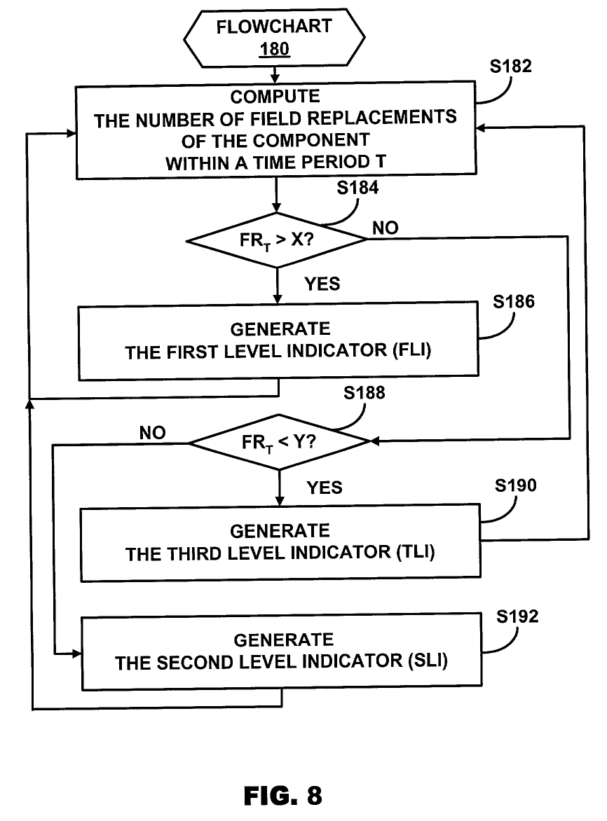

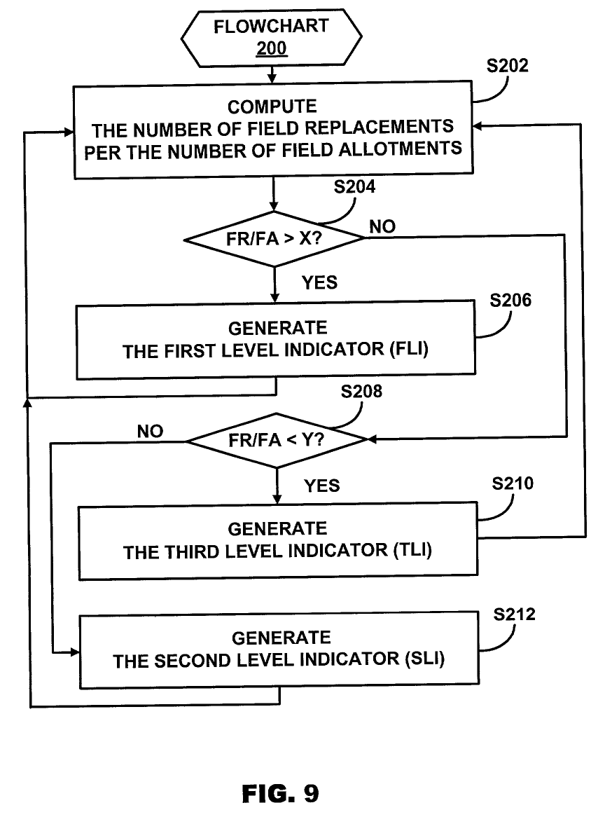

During a stage S146 of the flowchart 140, the application module 51 and the statistical analysis module 82 generate and communicate either the first level indicator FLI, the second level indicator SLI, or the third level indicator TLI as illustrated in FIG. 1. In one embodiment, during the stage S146, the application module 51 and the statistical analysis module 82 implement a first embodiment of a field replacement indicator generation method of the present invention that will be subsequently described herein in connection with FIG. 8 or a second embodiment of a field replacement indicator generation method of the present invention that will be subsequently described herein in connection with FIG. 9.

The communication of the first level indicator FLI, the second level indicator SLI, or the third level indicator TLI is on a recurring basis (e.g., once a day) for embodiments of the stage S146 where all three field replacements indicators can be generated. The communication of the first level indicator FLI and/or the second level indicator SLI is preferably upon a generation of the first level indicator FLI and/or the second level indicator SLI for embodiments of the stage S146 where only the first level indicator FLI and/or the second level indicator SLI can be generated.

Various forms of communication can be implemented, such as, for example, a transmission of a high priority e-mail addressed to a monitor 83 (FIG. 1) from the monitor server 80 (FIG. 1) to the monitor workstation 81 (FIG. 1), a faxing of a document by the monitor server 80 to a fax machine (not shown) associated with the monitor 83, a voice call/voice mail of a message by the monitor server 80 to a telephone associated with the monitor 83, and a paging of a message by the monitor server 80 to a pager (not shown) associated with the monitor 83.

An initial implementation of the flowchart 140 preferably involves a sequential execution of the stages S142-S146. Any sequential combination and any non-sequential combination of the stages S142-S146 can be executed during subsequent implementations of the flowchart 140.

Those having ordinary skill in the art will appreciate various benefits from an implementation of the flowchart 140. One benefit is a detection by the monitor 83 (FIG. 1) of field issues related to the component based upon the measurable standards of the first level indicator FLI and the second level indicator SLI. Another benefit is the development of report templates within the system 10 whereby the monitor 81 or another person associated with the private intranet can generate various reports directed to the number of field replacements of the component.

FIG. 5 illustrates a flowchart 150 as a representation of the field allotment extraction method of the present invention. During a stage S152 of the flowchart 150, the application module 51 and the relational database management module 62 control an extraction and a storage, respectively, of dealer information data DID from a DID database 90 into the relational tables 63 of the relational database 61 as illustrated in FIG. 3. The DID database 90 is a component of the private intranet employing the system 10 which stores information related to dealers associated within the private intranet, such as, for example, names, addresses, identification codes and units offered for sale by the dealers.

During a stage S154 of the flowchart 150, the application module 51 and the relational database management module 62 control an extraction and a storage, respectively, of the field allotment data FAD from a MGO database 91 into the relational tables 63 the relational database 61 as illustrated in FIGS. 1 and 3. The MGO database 91 is a component of the private intranet employing the system 10 which stores information related to allotments of the component for the field, such as, for example, the volume of the component purchased and shipped to assembly plants as identified by part numbers, and the volume of the component employed on goods. The storage dealer information data DID and the field allotment data FAD are related within the relational tables 63 of the relational database 61 to facilitate a generation of field information data FID (FIG. 1) that is subsequently explained in connection with FIGS. 8 and 9.

While, a sequential execution of the stages S152 and S154 is illustrated, the stages S152 and S154 can be executed in any order or singly executed during implementations of the flowchart 150. Preferably, the flowchart 150 is implemented at least once a week.

FIG. 6 illustrates a flowchart 160 as a representation of the field replacement data presentation method of the present invention. The flowchart 160 is implemented in response to a dealer 111 (FIG. 1) needing to input dealer field data DFD corresponding to less than optimal performance of the component into the relational database 61, or an inspector 121 (FIG. 1) needing to input inspector field data IFD corresponding to the sub-optimal performance of the component into the relational database 61 after an inspection of the component as shipped to the inspector 121 by the dealer 111. The dealer field data DFD and the inspector field data IFD are elements of the field replacement data FRD.

During a stage S162 of the flowchart 160, the presentation module 32 controls a presentation of either a dealer form DF in HyperText Markup Language (“HTML”) to the dealer 111 via the dealer PC or workstation 110 in as illustrated in FIGS. 1 and 2 upon a successful login and corresponding form request by the dealer 111, or a presentation of an inspector form IF in HTML to the inspector 121 via the inspector PC or workstation 120 illustrated in FIGS. 1 and 2 upon a successful login and corresponding form request by the inspector 121. A successful login is accomplished by the dealer 111 or the inspector 121 providing login information LI to the security module 41 and receiving an access authorization AA from the security module 41 as illustrated in FIG. 2.

In one embodiment, the dealer form DF and the inspector form IF includes entries for information about the dealer 111 (e.g., dealer code, address and location), entries for information about the unit employing the component (e.g., make, serial no. or identification no., usage data, repair order and repair date), and entries for information about the component (e.g., brand, type, name, size, and reason for sub-optimal performance). Additional entries are a checkbox indicative of need for further repair to the unit employing the component due to the sub-optimal performance of the component, and a checkbox indicative of a recall of the component. The dealer form DF allows the dealer 111 to input the dealer field data DFD in the appropriate entries. The inspector form IF includes the dealer field data DFD inputted by the dealer 111, and allows the inspector 121 to input the inspector field data IFD in appropriate entries, in particular the entry for reason of suboptimal performance of the component. The inspector form IF further allows the inspector 121 to correct any inaccuracies in entries for information about the component as inputted by the dealer 111 via the dealer form DF.

An example of a subset of entries for information about the component includes a performance criteria number (“PCN”), a regulatory code, and an adjustment reason code. The PCN for a part may be identified on the part itself, and is inputted by the dealer 111. The regulatory code may also be identified on the part, and is inputted by the dealer 111. The adjustment reason code is inputted by the inspector 121, and can be a any of a range of codes that associate to the performance level of the part (e.g., any reasons for sub-optimal performance).

During a stage S164 of the flowchart 160, the presentation module 51 conventionally downloads the dealer field data DFD inputted into the dealer form DF upon a completion of the dealer form DF by the dealer 111, or conventionally downloads the inspection field data IFD inputted into the inspection form IF upon a completion of the inspection form IF by the inspector 121.

During a stage S166 of the flowchart 160, the application module 51 controls an extraction of the dealer field data DFD or the inspector field data IFD from the presentation module 51, and the relational database management module 62 controls a storage of the dealer field data DFD or the inspector field data IFD into the relational tables 63 of the relational database 61. The dealer field data DFD and the inspector field data IFD when stored within the relational tables 63 are related to the dealer information data DID and the field allotment data FAD to facilitate a generation of the field information data FID (FIG. 1) that is subsequently explained in connection with FIGS. 8 and 9.

During a stage S168 of the flowchart 160, the application module 52 automatically communicates a further repair-needed indicator RNI if the dealer field data DFD or the inspector field data IFD indicates the appropriate checkbox of the dealer form DF or the inspector form IF, respectively, was marked. The further repair needed indicator RNI is indicative of a field replacement of the component where a unit employing the component needs further repair due to sub-optimal performance of the component. Various forms of communication can be implemented, such as, for example, a transmission of a high priority e-mail addressed to the monitor 83 (FIG. 1) from the monitor server 80 (FIG. 1) to the monitor workstation 81 (FIG. 1), a faxing of a document by the monitor server 80 to a fax machine (not shown) associated with the monitor 83, a voice call/voice mail of a message by the monitor server 80 to a telephone associated with the monitor 83, and a paging of a message by the monitor server 80 to a pager (not shown) associated with the monitor 83.

Those having ordinary skill in the art will appreciate various benefits from an implementation of the flowchart 160. One benefit is a generation and transmission of a warranty transaction data WTD by the application module 51 to a WINS database 92 as illustrated in FIG. 3 upon completion of the dealer form DF by the dealer 111 whereby the dealer 111 can receive a timely and verified credit or payment for the replaced component. Another benefit is a requisition of a shipping label SL from a shipping label database 130 (e.g., a database maintained and accessible over the public internet 100 by United Parcel Service) by the application module 51 as illustrated in FIG. 3 upon completion of the dealer form DF by the dealer 111. The application module 51 initiates a transmission of shipping label SL to the dealer PC or workstation 110 whereby the dealer 111 can print out the shipping label SL for immediate shipment of the component to the inspector 111.

FIG. 7 illustrates a flowchart 170 as a representation of the field replacement data requisition method of the present invention. During a stage S172 of the flowchart 170, the data batch module 31 receives the inspector data batch IDB (e.g., a download based upon the File Transfer Protocol) from the inspector PC or workstation 120 (FIG. 1) as inputted by the inspector 111. The inspector data batch IDB includes the corresponding inspector field data IFD and any other necessary information.

During a stage S174 of the flowchart 160, the application module 51 controls an extraction of the inspector field data IFD from the inspector data batch IDB, and the relational database management module 62 controls a storage of the inspector field data IFD into the relational tables 63 of the relational database 61. The inspector field data IFD when stored within the relational tables 63 are related to the dealer information data DID and the field allotment data FAD to facilitate a generation of the field information data FID (FIG. 1) that is subsequently explained in connection with FIGS. 8 and 9.

Those having ordinary skill in the art will appreciate various benefits from an implementation of the flowchart 170. One benefit is the ability of the inspector 111 to provide a substantial amount of inspector field data IFD in one communication as opposed to the individual inspector field data IFD communicated via the inspector form IF.

FIG. 8 illustrates a flowchart 180 as a representation of the field indicator generation method of the present invention. The flowchart 180 is preferably implemented by the application module 51 and the statistical analysis module 82 on a continual basis. For purposes of describing the flowchart 180, the number of field replacements of the component within a time period T where 0<T < is symbolized as a rate FR_{T}.

During a stage S182 of the flowchart 180, the statistical analysis module 82 computes the rate FR_{T} based upon the field information data FID retrieved from the relational database 61 by the application module 61. The field information data FID is a compilation of the field replacement data FRD within the time period T to facilitate the generation of the rate FR_{T} by the statistical analysis module 82. In various embodiments, the application data 51 aggregates or segregates, partially or fully, the field replacement data FRD by high priority codes and low priority codes; and/or omits the field replacement data FRD associated with the low priority codes for the component and/or a recall of the component.

During a stage S184 of the flowchart 180, the statistical analysis module 82 determines if the FR_{T} is greater than the threshold X. The threshold X in this case is a measurable standard (e.g., a specified number) that indicates potential field issues with the number of field replacements of the component within the time period T. Accordingly, the statistical analysis module 82 generates the first level indicator FLI during a stage S186 of the flowchart 180 when the rate FR_{T} is greater than the threshold X.

Otherwise, during a stage S188 of the flowchart 180, statistical analysis module 82 determines if the rate FR_{T} is greater than the threshold Y. The threshold Y in this case is a measurable standard (e.g., a specified number) that does not indicate any potential field issues with the number of field replacements of the component within the time period T. Accordingly, the statistical analysis module 82 generates the third level indicator TLI during a stage S190 of the flowchart 180 when the rate FR_{T} is less than the threshold Y. Otherwise, the statistical analysis module 82 generates the second level indicator SLI during a stage S192 of the flowchart 180 when the rate FR_{T} is between the threshold X and the threshold Y.

In an alternative embodiment of the flowchart 180, the stage S190 is omitted whereby the first level indicator FLI and the second level indicator SLI are the only field replacement indicators generated. As such, the automatic communication of a field replacement indicator during stage S146 (FIG. 4) would occur only upon a generation of either the first level indicator FLI and the second level indicator SLI. In a second alternative embodiment of the flowchart 180, the stages S188-S192 are omitted whereby the first level indicator FLI is the only field replacement indicator generated. As such, the automatic communication of a field replacement indicator during stage S146 would occur only upon a generation of the first level indicator FLI.

FIG. 9 illustrates a flowchart 200 as a representation of the field indicator generation method of the present invention. The flowchart 200 is preferably implemented by the application module 51 and the statistical analysis module 82 on a continual basis. For purposes of describing the flowchart 200, the rate of field replacements of the component per field allotments of the component is symbolized as a rate FR/FA.

During a stage S202 of the flowchart 200, the statistical analysis module 82 computes the rate FR/FA based upon the field information data FID retrieved from the relational database 61 by the application module 61. The field information data FID is a compilation of the field replacement data FRD and the field allotment data FAD to facilitate the generation of the rate FR/CP by the statistical analysis module 82. In various embodiments, the application data 51 aggregates or segregates, partially or fully, the field replacement data FRD by high priority codes and low priority codes; and/or omits the field replacement data FRD associated with the low priority codes for the component and/or a recall of the component.

During a stage S204 of the flowchart 200, the statistical analysis module 82 determines if the rate FR/CP is greater than the threshold X. The threshold X in this case is a measurable standard (e.g., in parts per million) that indicates potential field issues with the rate of field replacements of the component per field allotments of the component. Accordingly, the statistical analysis module 82 generates the first level indicator FLI during a stage S206 of the flowchart 200 when the rate FR/FA is greater than the threshold X.

Otherwise, during a stage S208 of the flowchart 200, statistical analysis module 82 determines if the rate FR/FA is greater than the threshold Y. The threshold Y in this case is a measurable standard (e.g., in parts per million) does not indicate any potential field issues with the number of field replacements of the component within the time period T. Accordingly, the statistical analysis module 82 generates the third level indicator TLI during a stage S210 of the flowchart 200 when the rate FR/FA is less than the threshold Y. Otherwise, the statistical analysis module 82 generates the second level indicator SLI during a stage S212 of the flowchart 200 when the rate FR/FA is between the threshold X and the threshold Y.

In an alternative embodiment of the flowchart 200, the stage S210 is omitted whereby the first level indicator FLI and the second level indicator SLI are the only field replacement indicators generated. As such, the automatic communication of a field replacement indicator during stage S146 (FIG. 4) would occur only upon a generation of either the first level indicator FLI and the second level indicator SLI. In a second alternative embodiment of the flowchart 200, the stages S208-S212 are omitted whereby the first level indicator FLI is the only field replacement indicator generated. As such, the automatic communication of a field replacement indicator during stage S146 would occur only upon a generation of the first level indicator FLI.

Referring again to FIGS. 1-3, other embodiments of a system in accordance with the present invention may install the illustrated software modules in more or less hardware components as illustrated, and/or in different hardware components. Additionally, the illustrated software modules may be combined in any combination or partitioned into further software modules. Also, the illustrated software modules can be partially or fully implemented as hardware modules.

While the system 10 is described herein as managing the field replacements of one component, the system 10 as well as other embodiments of a system in accordance with the present invention can monitor the field replacements of multiple components.

While the embodiments of the present invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

We claim:

1. A method of operating a system in monitoring one or more field replacements of a component, said method comprising:
storing field replacement data representative of the one or more field replacements of the component; and
communicating a field replacement indicator indicative of the number of field replacements of the component.

2. The method of claim 1, further comprising:
establishing a communication with a public internet; and
receiving the field replacement data from a device connected to the public internet.

3. A method of operating a system in monitoring one or more field replacements of a component, said method comprising:
storing field replacement data representative of one or more field replacements of the component within a time period;
computing a number of field replacements of the component within the time period; and
communicating a field replacement indicator indicative of the number of field replacements of the component within the time period.

4. The method of claim 3, further comprising:
establishing a communication with a public internet; and
receiving the field replacement data from a device connected to the public internet.

5. A method of operating a system in monitoring one or more field replacements of a component, said method comprising:
storing field allotment data representative of one or more allotments of the component in the field;
storing field replacement data representative of one or more field replacements of the component;
computing a rate of field replacements of the component per field allotments of the component; and
communicating a field replacement indicator indicative of the rate of field replacements of the component per field allotments of the component.

6. The method of claim 5, further comprising:
establishing a communication with a public internet; and
receiving the field replacement data from a device connected to the public internet.

7. A method of operating a system in monitoring one or more field replacements of a component, said method comprising:
storing field replacement data representative of a field replacement of the component; and
communicating a further repair needed indicator when the field replacement data indicates a unit employing the component in the field needs further repair due to a sub-optimal performance of the component.

8. The method of claim 7, further comprising:
establishing a communication with a public internet; and
receiving the field replacement data from a device connected to the public internet.

9. A system for monitoring one or more field replacements of a component, said system comprising:
a database operable to store field replacement data representative of one or more field replacements of the component; and
one or more modules operable to control a storage of the field replacement data in said database,
wherein said one or more modules are further operable to communicate a field replacement indicator indicative of the number of field replacements of the component.

10. The system of claim 9, wherein the field replacement indicator indicates the number of field replacements is greater than a measurable threshold.

11. The system of claim 9, wherein the field replacement indicator indicates the number of field replacements is less than a measurable threshold.

12. The system of claim 9, wherein the field replacement indicator indicates the number of field replacements is between a first measurable threshold and a second measurable threshold.

13. The system of claim 9, wherein:
said one or more modules are further operable to establish a communication with a public internet; and
said one or more modules are further operable to receive the field replacement data from a device connected to the public internet.

14. A system for monitoring one or more field replacements of a component, said system comprising:
a database operable to store field replacement data representative of one or more field replacements of the component within a time period; and
one or more modules operable to control a storage of the field replacement data in said database,
wherein said one or more modules are further operable to compute a number of field replacements of the component within the time period, and
wherein said one or more modules are further operable to communicate a field replacement indicator indicative of the number of field replacements of the component within the time period.

15. The system of claim 14, wherein the field replacement indicator indicates the number of field replacements within the time period is greater than a measurable threshold.

16. The system of claim 14, wherein the field replacement indicator indicates the number of field replacements within the time period is less than a measurable threshold.

17. The system of claim 14, wherein the field replacement indicator indicates the number of field replacements within the time period is between a first measurable threshold and a second measurable threshold.

18. The system of claim 14, wherein:
said one or more modules are further operable to establish a communication with a public internet; and
said one or more modules are further operable to receive the field replacement data from a device connected to the public internet.

19. A system for monitoring one or more field replacements of a component, said system comprising:
a database operable to store field allotment data representative of one or more allotments of the component in the field, said database further operable to store field replacement data representative of one or more field replacements of the component within a time period; and
one or more modules operable to control a storage of the field allotment data and the field replacement data in said database,
wherein said one or more modules are further operable to compute a rate of field replacements of the component per field allotments of the component, and
wherein said one or more modules are further operable to communicate a field replacement indicator indicative of the rate of field replacements of the component per field allotments of the component.

20. The system of claim 19, wherein the field replacement indicator indicates the rate of field replacements of the component per field allotments of the component is greater than a measurable threshold.

21. The system of claim 19, wherein the field replacement indicator indicates the rate of field replacements of the component per field allotments of the component is less than a measurable threshold.

22. The system of claim 19, wherein the field replacement indicator indicates the rate of field replacements of the component per field allotments of the component is between a first measurable threshold and a second measurable threshold.

23. The system of claim 19, wherein:
said one or more modules are further operable to establish a communication with a public internet; and
said one or more modules are further operable to receive the field replacement data from a device connected to the public internet.

24. A system for monitoring one or more field replacements of a component, said system comprising:
a database operable to store field replacement data representative of a field replacement of the component within a time period; and
one or more modules operable to control a storage of the field replacement data in said database,
wherein said one or more modules are further operable to communicate a further repair needed indicator when the field replacement data indicates a unit employing the component in the field needs further repair due to an sub-optimal performance of the component.

25. The system of claim 24, wherein:
said one or more modules are further operable to establish a communication with a public internet; and
said one or more modules are further operable to receive the field replacement data from a device connected to the public internet.

26. A method of operating a system in monitoring a field replacement of a component, said method comprising:
establishing a communication with a public internet;
presenting a dealer form to a first device connected to the public internet;
receiving dealer field data inputted in the dealer form;
presenting an inspector form to a second device connected to the public internet;
receiving inspector field data inputted in the inspector form; and
storing the dealer field data and the inspector field data as field replacement data representative of the field replacement of the component.

27. A system for monitoring a field replacement of a component, said system comprising:
a database operable to store dealer field data and inspector field data; and
one or more modules operable to establish a communication with a public internet,
wherein said one or more modules are further operable to present a dealer form to a first device connected to the public internet, to receive dealer field data inputted in the dealer form, to present an inspector form to a second device connected to the public internet, to receive inspector field data inputted in the inspector form, and to store the dealer field data and the inspector field data in said database as field replacement data representative of the field replacement of the component.
